(19) United States
(12) Patent Application Publication
(10) Pub. No.: US 2023/0008797 A1
(43) Pub. Date: Jan. 12, 2023

(54) Hand-Held Machine Tool Comprising a Planetary Gearbox

(71) Applicant: Robert Bosch GmbH, Stuttgart (DE)

(72) Inventors: Dietmar Saur, Moessingen (DE); Tobias Herr, Stuttgart (DE); Christian Lang, Stuttgart (DE); Simon Erbele, Nufringen (DE)

(21) Appl. No.: 17/785,338

(22) PCT Filed: Dec. 16, 2020
(86) PCT No.: PCT/EP2020/086377

§ 371 Date: Jun. 14, 2022

(30) Foreign Application Priority Data
Dec. 19, 2019 (DE) 10 2019 220 245.4

(51) Int. Cl. B25F 5/00

(52) U.S. Cl. CPC B25F 5/001

(57) ABSTRACT

The disclosure relates to a hand-held machine tool with a drive unit for driving a tool holder, wherein the drive unit is paired with a planetary gearbox, which is arranged in a gearbox housing and comprises at least one ring gear, and an intermediate shaft, said intermediate shaft being connected to a planet carrier of the planetary gearbox. According to the disclosure, the at least one ring gear is paired with a fixing element which is designed to fix the at least one ring gear in the gearbox housing in the longitudinal direction of the ring gear rotational axis, said fixing element being arranged on the ring gear and/or the intermediate shaft.

### PRIOR ART

The present invention relates to a handheld power tool with a drive unit for driving a tool holder, the drive unit being assigned a planetary transmission, which is arranged in a transmission housing and has at least one ring gear, and an intermediate shaft, the intermediate shaft being connected to a planet carrier of the planetary transmission.

Such a handheld power tool with a planetary transmission is known from the prior art, where the ring gear is fixed in the transmission housing in the axial direction by a locking ring. In addition, a handheld power tool with a planetary transmission is known from DE 10 2016 224 259 A1, where the ring gear is fastened to the transmission housing via a screw connection. The ring gear has an external thread, and the transmission housing has an internal thread, which threads together form the screw connection.

### DISCLOSURE OF THE INVENTION

The invention relates to a handheld power tool with a drive unit for driving a tool holder, the drive unit being assigned a planetary transmission, which is arranged in a transmission housing and has at least one ring gear, and an intermediate shaft, the intermediate shaft being connected to a planet carrier of the planetary transmission. The at least one ring gear is assigned a fixing element which is designed to fix the at least one ring gear in the transmission housing in the longitudinal direction of the ring gear rotation axis, the fixing element being arranged on the ring gear and/or on the intermediate shaft.

The invention thus permits the provision of a handheld power tool with a planetary transmission, in which the ring gear can be securely and reliably fixed in the axial direction in the transmission housing via the fixing element. An arrangement of the ring gear in the transmission housing can thus be made possible in a simple and uncomplicated manner, whereby a separate securing element can be dispensed with.

The fixing element is preferably arranged at least in sections on the intermediate shaft at an axial end of the at least one ring gear facing toward the tool holder.

A suitable arrangement of the fixing element can thus be made possible in a simple manner.

The fixing element is preferably formed integrally on the planet carrier.

A space-saving design of the intermediate shaft with the fixing element can thus be made possible.

According to one embodiment, the fixing element is designed as a radial extension at least in sections on an outer circumference of the planet carrier.

A stable and robust fixing element can thus be provided.

According to a further embodiment, the fixing element is arranged on the ring gear at an axial end of the ring gear facing away from the tool holder.

An alternative arrangement of the fixing element can thus be made possible in a simple manner.

The fixing element is preferably designed as a circumferential collar at least in sections on an inner circumference of the ring gear.

A compact design of the ring gear with the fixing element can thus be made possible.

The planetary transmission is preferably a single-stage transmission.

A suitable planetary transmission can thus be provided in a simple and uncomplicated manner.

According to one embodiment, the fixing element is designed in one piece with the ring gear or the intermediate shaft or formed integrally thereon or is permanently connected to the ring gear or the intermediate shaft.

An arrangement of the fixing element on the ring gear or on the intermediate shaft can thus be made possible in a simple manner.

The ring gear preferably has an anti-rotation device.

This allows the ring gear to be fixed in the transmission housing in the axial direction and in the circumferential direction.

The intermediate shaft is preferably designed to drive an impact mechanism.

A handheld power tool with an impact mechanism and with a planetary transmission can thus be made available.

### BRIEF DESCRIPTION OF THE DRAWINGS

The invention is explained in more detail in the following description on the basis of exemplary embodiments shown in the drawings, in which:

FIG. 1 shows a side view of a handheld power tool, with a transmission designed as a planetary transmission,

FIG. 2 shows a longitudinal section through the transmission of FIG. 1, wherein a ring gear assigned to the planetary transmission has a fixing element,

FIG. 3 shows a perspective view of the ring gear from FIG. 2,

FIG. 4 shows a longitudinal section through the transmission of FIG. 1, wherein an intermediate shaft assigned to the planetary transmission has a fixing element, and

FIG. 5 shows a perspective view of the intermediate shaft from FIG. 4.

### DESCRIPTION OF THE EXEMPLARY EMBODIMENTS

In the figures, elements having the same function or a comparable function are provided with identical reference signs and are described in detail once only.

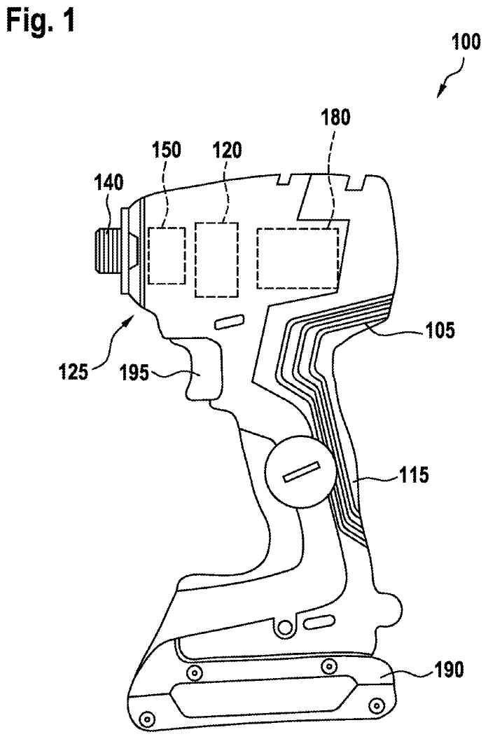

FIG. 1 shows an example of a handheld power tool 100 which has a housing 105 with a handle 115. According to one embodiment, the handheld power tool 100 is mechanically and electrically connectable to a battery pack 190 for mains-independent power supply, although as an alternative to this it can, for example, also be operated in a mains-dependent manner.

A drive unit 125, 180 with at least one transmission unit 125 and with an electric drive motor 180, preferably supplied with power by the battery pack 190, is preferably located in the housing 105. The transmission unit 125 is preferably assigned at least one transmission 120. The at least one transmission 120 is preferably designed as a planetary transmission and is therefore referred to below as the “planetary transmission 120”.

The handheld power tool 100 is designed, for example, as a rotary impact driver with an impact mechanism 150. The impact mechanism 150 is preferably assigned to the transmission unit 125. It will be noted, however, that the present invention is not limited to rotary impact drivers and instead can generally be used in various handheld power tools with or without impact mechanism 150, which tools can have the drive motor 180 and the transmission unit 125, e.g. in cordless drills.

The drive motor 180 can be switched on and off via a manual switch 195, for example. The drive motor 180 is preferably designed as an electronically commutated motor.

The handheld power tool 100 is for example assigned a tool holder 140 for receiving an insert tool, for example a screwdriver bit. The drive motor 180 is preferably designed to drive the tool holder 140 and thus the insert tool.

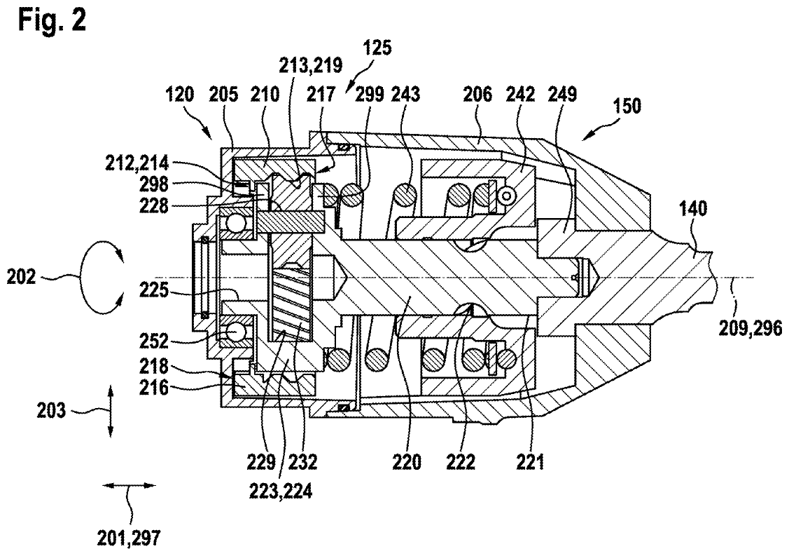

FIG. 2 shows the transmission unit 125 with the planetary transmission 120, the impact mechanism 150 and the tool holder 140 from FIG. 1. The planetary transmission 120 is preferably arranged in a transmission housing 205, and the impact mechanism 150 is arranged in an impact mechanism housing 206.

The impact mechanism 150 is preferably designed as a rotary impact mechanism, in particular a V-groove rotary impact mechanism. The impact mechanism 150 is preferably designed to convert a continuous power output of the drive motor 180 into a sudden angular momentum. The energy output of the drive motor 180 is passed on to the tool holder 140 by a striker 242 of the impact mechanism 150 striking a corresponding anvil 249 by means of a pulse of high power intensity.

The anvil 249 is preferably designed in one piece with the tool holder 140. The striker 242 is preferably mounted in such a way that a movement in the axial direction 201 of the transmission unit 125 or along a longitudinal axis 209 of the transmission unit 125 and a movement in the radial direction 203 or perpendicular to the longitudinal axis 209 are possible.

The movement in the axial direction 201 is preferably controlled via V-shaped grooves 222 and driver balls (not shown). A spring 243 ensures the return movement of the striker 242. Such an impact mechanism is sufficiently known from the prior art, which is why a detailed description is dispensed with here for the sake of brevity and clarity of the description.

The striker 242 is preferably arranged on an intermediate shaft 220, the V-shaped grooves 222 being arranged on a portion 221 of the intermediate shaft 220 facing toward the tool holder 140. The intermediate shaft 220 is preferably designed to drive the impact mechanism 150 and is mounted rotatably in the transmission housing 205 via a bearing element 252 facing away from the tool holder 140.

The intermediate shaft 220 is for example oriented at least substantially flush with a drive shaft (not shown) of the drive motor 180. Furthermore, the intermediate shaft 220 preferably has a receptacle 225, which is provided for at least partially receiving the drive shaft. The receptacle 225 preferably extends at least substantially along the longitudinal axis 209 of the transmission unit 125. In an installed state, the drive shaft protrudes at least partially into the intermediate shaft 220, in particular into the receptacle 225 of the intermediate shaft 220.

The planetary transmission 120 is preferably designed as a single-stage planetary transmission with a planet carrier 223 drivable by the drive shaft and with a plurality of planetary gears 232. Here, the intermediate shaft 220 preferably has the planet carrier 223 of the planetary transmission 120 at its end facing away from the tool holder 140. The intermediate shaft 220 preferably has a plurality of planetary gear receptacles and planetary gear bearing points 228 arranged in the circumferential direction. The planetary gear receptacles 229 are preferably designed at least substantially in the shape of a cylinder segment. Arranged in each planetary gear receptacle 229 is a planetary gear 232, which is rotatably mounted by means of a pin.

The intermediate shaft 220 preferably has three planetary gear receptacles 229, each with a planetary gear bearing point 228. The planetary gear receptacles 229 are separated from one another by webs 224 extending radially to the longitudinal axis 209 of the transmission unit 125. Viewed along the longitudinal axis 209 of the transmission unit 125, the planetary gear receptacles 229 are delimited by two disk-shaped wall elements 298, 299 which are arranged at least substantially perpendicular to the longitudinal axis 209. The wall elements 298, 299 are at least substantially circular. The wall elements 298, 299 are designed in one piece with the intermediate shaft 220.

The planetary transmission 120 preferably comprises at least one ring gear 210, which has a toothing 213 on its inner circumference 219 along its axis of rotation 296. The ring gear 210 is preferably arranged fixed to the housing and secured against rotation in the transmission housing 205.

In order to arrange the ring gear 210 in the transmission housing 205 in a manner secured against rotation, the ring gear 210 preferably has an anti-rotation device 216. For example, the anti-rotation device 216 is designed as at least one extension formed in the axial direction 201 or in the longitudinal direction 297 of the ring gear 210, the at least one extension being formed only in sections in the circumferential direction and being arranged in a receptacle of the transmission housing 205 and thus preventing rotation of the ring gear 210 about its axis of rotation 296. Preferably, at least one extension is provided; however, any desired number of extensions can be distributed in the circumferential direction.

It will be noted that the anti-rotation device 216 can also be designed as an extension designed in the radial direction 203. The anti-rotation device 216 is preferably formed at an end 218 of the ring gear 210 facing away from the tool holder 140, and the toothing 213 is arranged on an end 217 facing toward the tool holder 140.

The ring gear 210 is preferably assigned a fixing element 212, which is designed to fix the ring gear 210 in the axial direction 201 or in the longitudinal direction 297 in the transmission housing 205. The fixing element 212 is arranged on the ring gear 210 and/or the intermediate shaft 220. The fixing element 212 is preferably designed in one piece with the ring gear 210 and/or the intermediate shaft 220. Alternatively, the fixing element 212 can also be formed integrally on the ring gear 210 and/or the intermediate shaft 220. In addition, the fixing element 212 can also be permanently connected to the ring gear 210 and/or the intermediate shaft 220.

According to a further embodiment, the fixing element 212 can be designed as a separate part. The fixing element 212 can be designed in several parts. The fixing element 212 is preferably designed as a disk, in particular an annular disk.

The ring gear 210 preferably has an end 218 facing away from the tool holder 140, and an end 217 facing toward the tool holder 140. According to one embodiment, the fixing element 212 is arranged on the end 218 of the ring gear 210 facing away from the tool holder 140. The fixing element 212 is preferably formed as a circumferential collar 214 at least in sections on the inner circumference 219 of the ring gear 210. However, the fixing element 212 can also simply be designed as at least one circular segment portion. Alternatively, the fixing element 212 can also be designed as a disk which is arranged on the inner circumference 219 of the ring gear 210. The fixing element 212 embodied as a disk, in particular as an annular disk, can be assigned to a positioning portion. The positioning portion can be formed, for example, by a circumferential web or a washer. To fix the ring gear 210 in the longitudinal direction 297, the fixing element 212 is arranged on a side of the wall element 298 of the planet carrier 223 facing away from the tool holder 140.

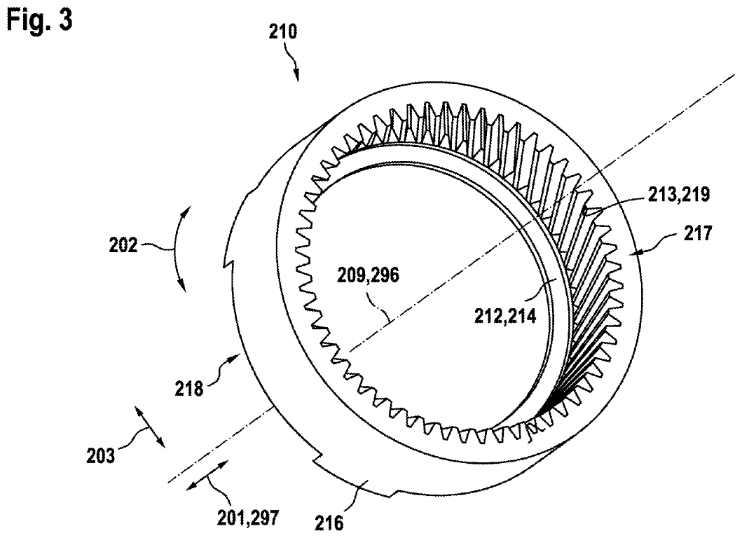

FIG. 3 shows the ring gear 210 of FIG. 2 with its toothing 213 arranged at the axial end 217 and with its anti-rotation device 216 at the opposite axial end 218, and also the fixing element 212, preferably formed as a circumferential collar 214. The circumferential collar 214 has a smaller inner radius than the toothing 213 of the ring gear 210.

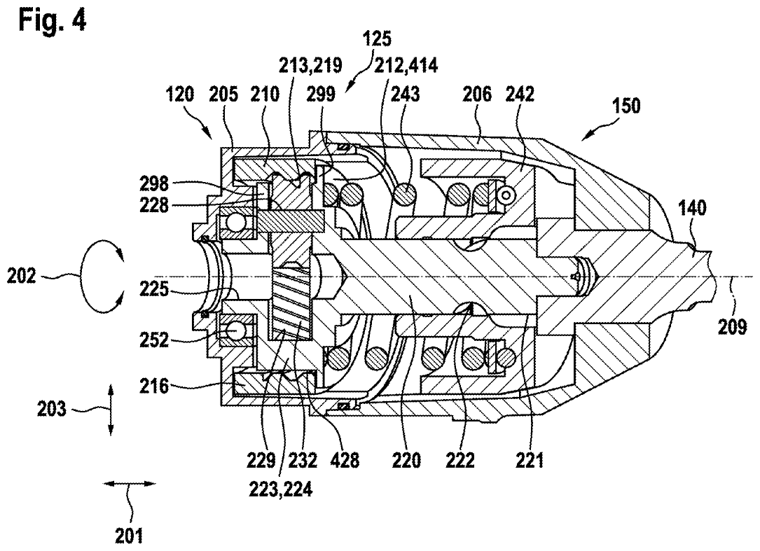

FIG. 4 shows the transmission unit 125 from FIG. 2, the fixing element 212 being arranged, according to an alternative embodiment, on the intermediate shaft 220. The fixing element 212 is arranged on the intermediate shaft 220 at the axial end 217 of the at least one ring gear 210 facing toward the tool holder 140. In particular, the fixing element 212 is integrally formed on the planet carrier 223.

Here, the fixing element 212 is preferably designed at least in sections on an outer circumference 428 of the planet carrier 223 as a radial extension 414 or as an extension in the radial direction 203 of the transmission unit 125. The fixing element 212 is preferably designed as a radial extension 414 of the wall element 299 of the planet carrier 223 facing toward the tool holder 140. The wall element 299 and the radial extension 299 are preferably formed in one piece. Alternatively, the fixing element can be designed as a disk, in particular as an annular disk, which is preferably arranged on the outer circumference 428 of the planet carrier 223. The fixing element 212 designed as a disk, in particular an annular disk, can be assigned to a positioning portion. The positioning portion can be formed, for example, by a circumferential web or a washer.

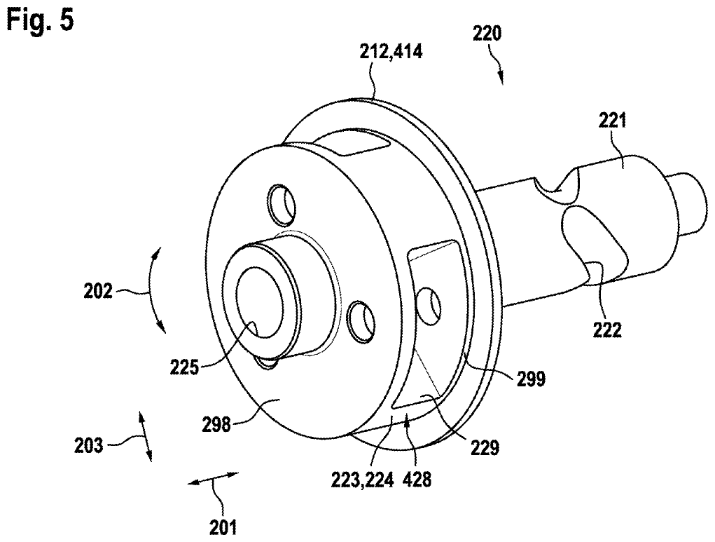

FIG. 5 shows the intermediate shaft 220 from FIG. 4 and illustrates the design of the fixing element 212 or the radial extension 414. Here, the fixing element 212 is designed as a circumferential collar analogously to the embodiment of FIG. 2 and FIG. 3. Furthermore, the fixing element 212 is preferably designed as a protective element for preventing particles from penetrating into the transmission 120. However, the fixing element 212 can also be designed as at least one circular segment portion. In addition, FIG. 5 illustrates the planetary gear receptacles 229.

It will be noted that the fixing element 212 can be arranged on the ring gear 210 or on the intermediate shaft 220 or the planet carrier 223. The fixing element 212 can be designed as a circumferential collar or as at least one circular segment portion. In addition, several circular segment portions distributed in the circumferential direction can also be provided. In addition, the fixing element 212 can be arranged on the ring gear 210 and the intermediate shaft 220 or the planet carrier 223. Alternatively, the transmission unit 125 can also be designed as a multi-stage planetary transmission 120.

1. A handheld power tool, comprising:
a drive unit configured to drive a tool holder, the drive unit assigned a planetary transmission, which is arranged in a transmission housing and has at least one ring gear, and an intermediate shaft, the intermediate shaft connected to a planet carrier of the planetary transmission, wherein
the at least one ring gear is assigned a fixing element which is designed to fix the at least one ring gear in the transmission housing in a longitudinal direction of a ring gear rotation axis, the fixing element arranged on the at least one ring gear and/or on the intermediate shaft.

2. The handheld power tool as claimed in claim 1, wherein the fixing element is arranged at least in sections on the intermediate shaft at an axial end of the at least one ring gear facing toward the tool holder.

3. The handheld power tool as claimed in claim 1, wherein the fixing element is integrally formed on the planet carrier.

4. The handheld power tool as claimed in claim 1, wherein the fixing element is designed as a radial extension at least in sections on an outer circumference of the planet carrier.

5. The handheld power tool as claimed in claim 1, wherein the fixing element is on the at least one ring gear and is arranged at an axial end of the at least one ring gear facing away from the tool holder.

6. The handheld power tool as claimed in claim 1, wherein the fixing element is designed as a circumferential collar at least in sections on an inner circumference of the at least one ring gear.

7. The handheld power tool as claimed in claim 1, wherein the planetary transmission is a single-stage transmission.

8. The handheld power tool as claimed in claim 1, wherein the fixing element is designed in one piece with the at least one ring gear or the intermediate shaft or formed integrally thereon, or is permanently connected to the at least one ring gear or the intermediate shaft

9. The handheld power tool as claimed in claim 1, wherein the at least one ring gear has an anti-rotation device.

10. The handheld power tool as claimed in claim 1, wherein the intermediate shaft is designed to drive an impact mechanism.
